(19) United States
(12) Patent Application Publication
(10) Pub. No.: US 2009/0251426 A1
(43) Pub. Date: Oct. 8, 2009

(54) Organic light emitting display device composed of multiple display panels

(76) Inventors: Patrick Lee, Suwon-si (KR); Chang-Hoon Lee, Suwon-si (KR); Myeong-Gil Choi, Suwon-si (KR)

Correspondence Address: ROBERT E. BUSHNELL & LAW FIRM, 2029 K STREET NW, SUITE 600, WASHINGTON, DC, 20006-1004, US

(21) Appl. No.: 12/379,185

(22) Filed: Feb. 13, 2009

(30) Foreign Application Priority Data
Apr. 3, 2008 (KR) 10-2008-0031088

(51) Int. Cl. G06F 3/041

(52) U.S. Cl. 345/173

(57) ABSTRACT

An organic light emitting display device that is used as a flat panel display and usable in a portable terminal that employs two separate display-panels. The organic light emitting display device has a first display panel and a second display panel provided on the same surface thereof; a touch screen panel (TSP) formed integrally on the first and second display panels; and one controller controlling the first and second display panels.

### CLAIM OF PRIORITY

This application makes reference to, incorporates the same herein, and claims all benefits accruing under 35 U.S.C. §119 from an application for ORGANIC LIGHT EMITTING DISPLAY DEVICE earlier filed in the Korean Intellectual Property Office on 3 Apr. 2008 and there duly assigned Serial No. 10-2008-0031088.

### BACKGROUND OF THE INVENTION

1. Field of the Invention

The present invention relates to an organic light emitting display device, and more particularly to an organic light emitting display device having a first display panel and a second display panel provided in the same surface thereof; and a touch screen panel integrally formed on the first and second display panels.

2. Description of the Related Art

A lot of people use portable terminals such as mobile phones or PDAs with the rapid spread of the portable terminals. Also, there has been an increasing demand for a small, slim and lightweight portable terminal so as to improve the portability of the portable terminal. Therefore, components installed in the portable terminals are manufactured small with an integrated semiconductor. In spite of a trend toward small portable terminals, one or more display devices installed in the portable terminals are required to promote user's convenience.

In recent years, the display devices installed in the portable terminals are divided into a main display unit and a minor display unit, and therefore the display devices are generally mounted in both sides of the portable terminals in the structural aspect. Here, the main display unit displays various images including information on telecommunications, and the minor display unit displays simple information such as a clock, a short message service (SMS), a ringer indicator, etc.

Also, flat panel displays such as LCD have been used as the display devices installed in the portable terminals. The flat panel displays has an advantage that they take up less space since their thickness is small compared to the conventional CRT, and display conditions for the portable terminals are satisfied due to the low power consumption.

However, the minor display unit as configured in the prior art has a disadvantage that its practical uses are poor due to its simple functions.

That is to say, a user may only realize certain applications such as menu selection, character transfer, DMB reception, photographing and video communications only through the main display unit. However, it is difficult for a user to realize the same various applications as in the main display unit through the minor display unit formed in the opposite surface of the main display unit, except for the simple functions as described above.

The above information disclosed in this Related Art section is only for enhancement of understanding of the background of the invention and therefore it may contain information that does not form the prior art that is already known to a person of ordinary skill in the art.

### SUMMARY OF THE INVENTION

Accordingly, the present invention is designed to solve such drawbacks of the prior art, and therefore an object of the present invention is to provide an organic light emitting display device as a flat panel display provided in a portable terminal, the organic light emitting display device having a first display panel and a second display panel provided in the same surface thereof; a touch screen panel (TSP) formed integrally on the first and second display panels; and one controller controlling the first and second display panels.

One embodiment of the present invention is achieved by providing an organic light emitting display device including first and second display panels formed on the same surface thereof; a touch screen panel formed integrally on the first and second display panels; a touch screen panel controller driving the touch screen panel; and a display controller controlling the first and second display panels.

In this case, each of the first and second display panels may include a first substrate formed with an image display unit including a plurality of thin film transistors and light emitting elements; and an encapsulation substrate formed on the first substrate to encapsulate the image display unit.

Also, the touch screen panel may be formed integrally on the encapsulation substrate, and include a transparent electrode formed on one surface of the encapsulation substrate; a metal electrode formed on edges or respective sides of the transparent electrode; and a polarizer film formed on the encapsulation substrate.

According to the present invention as described above, at least two display panels provided in a portable terminal is formed in one surface of the organic light emitting display device, and one touch screen panel is formed integrally on a large number of the display panels. Therefore, the organic light emitting display device according to the present invention may be useful to promote portable terminal user's interests and reduce the production cost when compared to the conventional organic light emitting display device in which a separate touch screen panel is formed on each of the display panels.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicated the same or similar components, wherein:

FIG. 1 is a schematic block diagram showing an organic light emitting display device according to one exemplary embodiment of the present invention.

FIG. 2 is a cross-sectional view showing one region of first and second display panels and a touch screen panel as show in FIG. 1.

### DETAILED DESCRIPTION OF THE INVENTION

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. In addition, when an element is referred to as being “on” another element, it can be directly on the element or be indirectly on the element with one or more intervening elements interposed therebetween. Also, when an element is referred to as being “connected to” another element, it can be directly connected to the element or be indirectly connected to the element with one or more intervening elements interposed therebetween. Hereinafter, like reference numerals refer to like elements.

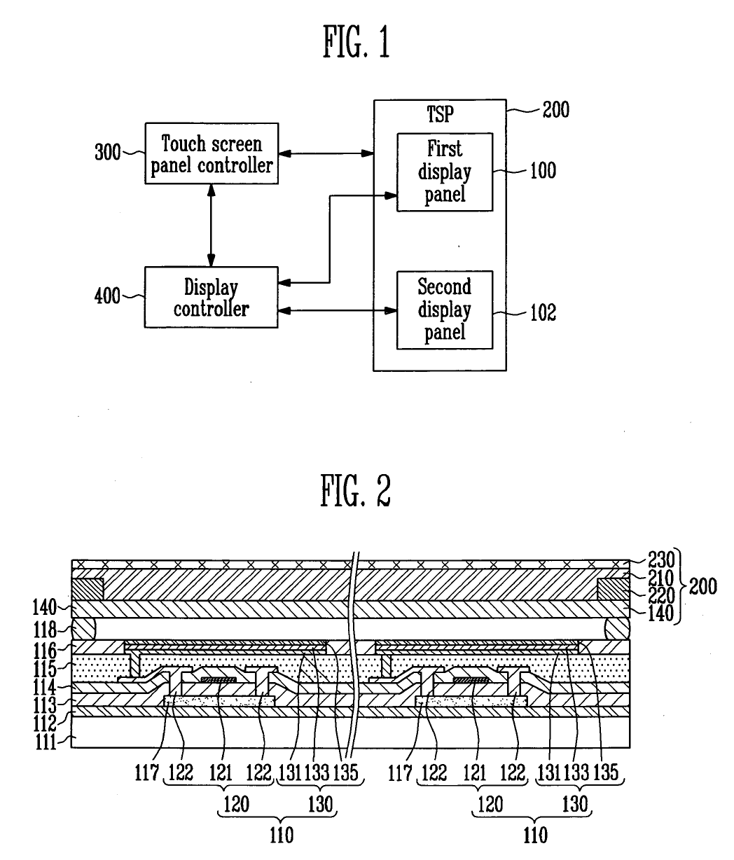

FIG. 1 is a schematic block diagram showing an organic light emitting display device according to one exemplary embodiment of the present invention.

Referring to FIG. 1, the organic light emitting display device according to one exemplary embodiment of the present invention includes a first display panel 100 and a second display panel 102 formed on the same surface thereof; a touch screen panel 200; a touch screen panel controller 300; and a display controller 400. Here, the touch screen panel 200 is formed integrally on the first and second display panels, and the touch screen panel controller 300 drives the touch screen panel. The display controller 400 controls the first and second display panels.

A schematic operation of the organic light emitting display device according to one exemplary embodiment of the present invention will be described as follows.

First, when a menu screen is displayed by the display controller 400 on an image display unit provided in the first display panel 100, a user selects a certain menu by contacting one region of the touch screen panel 200 that is formed on the first display panel 100 so as to select the certain menu output on the menu screen.

Then, the touch screen panel 200 transmits information on contact points to the touch screen panel controller 300. At this time, the information includes analog signals of voltage information on the contact points, and the touch screen panel controller 300 converts the analog signals into a digital signal and transmits the digital signal to the display controller 400.

Then, the display controller 400 processes the input digital signal and outputs data corresponding to the digital signal into the first and/or second display panels 100 and 102. A user may view his selection results through the image display units of the first and/or second display panels.

At this time, the first display panel 100 and the second display panel 102 are realized with organic light emitting display panels.

Also, it is characterized in that one touch screen panel 200 is formed integrally on the first and second display panels, and this configuration will be described in more detail with reference to FIG. 2.

According to the organic light emitting display device according to one exemplary embodiment of the present invention as described above, the first and second display panels 100 and 102 are formed in one surface thereof, and a touch screen panel 200 is formed integrally on the first and second display panels 100 and 102. Therefore, it is possible for a user to drive various applications using the first and second display panels 100 and 102 without any distinction of the main display and the minor display. Also, the production cost may be reduced in the organic light emitting display device of the present invention when compared to the conventional organic light emitting display devices in which a separate touch screen panel is formed on each of the display panels.

FIG. 2 is a cross-sectional view showing one region of first and second display panels and a touch screen panel as show in FIG. 1.

Referring to FIG. 2, the organic light emitting display device includes a first substrate 111, an encapsulation substrate 140, and a touch screen panel 200. Here, the first substrate 111 has image display units 110 of the first and second display panels formed respectively therein, and the encapsulation substrate 140 is formed on the first substrate to encapsulate the image display units formed on the first substrate. The touch screen panel 200 is formed integrally on the encapsulation substrate.

At this time, FIG. 2 shows that the image display units 110 formed respectively in the first and second display panels are formed on the same first substrate 111, and the same encapsulation substrates 140 are provided to encapsulate each of the image display units 110. However, this is merely one exemplary embodiment for convenience' sake of the description, but the image display units of the first and second display panels may be formed respectively on the separate substrates, and therefore the encapsulation substrates may also be formed on the separate substrates.

However, the touch screen panel 200 is characterized in that it is formed integrally on the first and second display panels, that is, at least one encapsulation substrate regardless of the fact that the encapsulation substrate is used alone.

Each of the image display units 110 formed respectively on the first substrate 111 includes a plurality of thin film transistors 120 and a plurality of light emitting elements 130. That is to say, a buffer layer 112 and a semiconductor layer 117 are sequentially formed on the first substrate 111, and a gate insulator 113, a gate electrode 121, an interlayer insulator 114, a source and drain electrode 123, and a passivation layer 115 are formed on the semiconductor layer 117. At this time, the thin film transistor 120 includes a semiconductor layer 117, a gate electrode 120, a source and a drain electrode 122, and a light emitting element 130 is formed on the thin film transistor 120, being electrically coupled to the thin film transistor 120 through a contact hole (not shown) formed in the passivation layer 115.

The light emitting element 130 includes an anode electrode 131, a light emitting layer 133, and a cathode electrode 135. A pixel definition layer 116 is formed on the anode electrode 131 and the passivation layer 115.

Also, an encapsulation substrate 140 is formed on the image display unit 110 including the thin film transistor 120 and the light emitting element 130 so as to encapsulate the thin film transistor 120 and the light emitting element 130 in addition to the first substrate 111. At this time, the first substrate 111 and the encapsulation substrate 140 are encapsulated by a sealant 118, and the encapsulation substrate 140 may be realized with an insulating substrate such as transparent glass. A transparent moisture absorbing agent (not shown) may be installed in the bottom surface of the encapsulation substrate 140 to absorb moisture that remains in a space between the encapsulation substrate 140 and the first substrate 111.

This exemplary embodiment of the present invention is characterized in that the touch screen panel 200 is formed integrally on the encapsulation substrate 140, and therefore it is preferred to realize the touch screen panel 200 with a touch screen panel that is driven in a capacitive manner.

That is to say, a transparent electrode 210 is coated onto the encapsulation substrate 140 and a metal electrode 220 is formed on edges or respective sides of the transparent electrode 210 in the case of the exemplary embodiment as shown in FIG. 2.

At this time, indium tin oxide (ITO) is used as the transparent electrode 210. Also, the metal electrode 220 forms a resistor network around the transparent electrode 210. The resistor network is formed in a linearization pattern to uniformly transmit a control signal to the entire surface of the transparent electrode 210.

Meanwhile, the metal electrode 220 may be formed of materials such as silver. The metal electrode 220 may be formed by directly printing a silk screen on the transparent electrode 210 and heating the transparent electrode 210, or formed by depositing a conventional conductive material on the transparent electrode 210 and patterning the conductive material.

In addition, a polarizer film 230 is formed in the entire surface of the encapsulation substrate 140 including the metal electrode 220.

The polarizer film 230 is flexible and functions to selectively transmit the light entered from the outside. The visibility of images displayed through the organic light emitting display device may be improved by preventing the reflection of external light through the polarizer film 230.

Also, the polarizer film 230 prevents an electrical short circuit between conductive styluses or fingers and the transparent electrode 210. Therefore, the capacitive touch screen panel 200 may detect a touch point in which a voltage drop occurs when the conductive styluses or the fingers are positioned on the polarizer film 230, or touch the polarizer film 230.

Meanwhile, the capacitive touch screen panel 200 is continuously charged and discharged. At this time, analog measurement circuits (current sensors) are coupled to four edges of the touch screen panel 200 to measure a charge capacity. This capacitive touch screen panel 200 is a bended or flat glass coated with a transparent metal oxide layer, and determines a touch point in which a voltage drop occurs when a voltage is applied to four corners of the touch screen panel 200 so that a uniform electric field can be formed, and a picture is then drawn with the fingers and the conductive styluses.

While the present invention has been described in connection with certain exemplary embodiments, it is to be understood that the invention is not limited to the disclosed embodiments, but, on the contrary, is intended to cover various modifications and equivalent arrangements included within the spirit and scope of the appended claims, and equivalents thereof.

What is claimed is:

1. An organic light emitting display device, comprising:
first and second display panels formed on the same surface thereof;
a touch screen panel formed integrally on the first and second display panels;
a touch screen panel controller driving the touch screen panel; and
a display controller controlling the first and second display panels.

2. The organic light emitting display device according to claim 1, wherein each of the first and second display panels comprises:
a first substrate formed with an image display unit including a plurality of thin film transistors and light emitting elements; and
an encapsulation substrate formed on the first substrate to encapsulate the image display unit.

3. The organic light emitting display device according to claim 2, wherein the touch screen panel is formed integrally on the encapsulation substrate.

4. The organic light emitting display device according to claim 3, wherein the touch screen panel comprises:
a transparent electrode formed on one surface of the encapsulation substrate;
a metal electrode formed on edges or respective sides of the transparent electrode; and
a polarizer film formed on the encapsulation substrate.

5. The organic light emitting display device according to claim 1, wherein the touch screen panel is driven in a capacitive manner.

6. A display device, comprising:
a substrate;
a first display panel disposed on a surface of said substrate;
a second display panel disposed on said surface of said substrate adjacent to said first display; and
a touch screen panel formed integrally on both said first display panel and said second display panel,
wherein said first display panel and said second display panel each can display images simultaneously.

7. The display device recited in claim 6, further comprising:
a touch screen panel controller driving the touch screen panel; and
a display controller controlling the first and second display panels.

8. The display device recited in claim 6, wherein the substrate includes a plurality of thin film transistors and light emitting elements.

9. The display device recited in claim 8, wherein each of the first and second display panels further comprises:
an encapsulation substrate formed on the substrate to encapsulate the image display unit.

10. The display device recited in claim 9, wherein the touch screen panel is formed integrally on the encapsulation substrate.

11. The display device recited in claim 10, wherein the touch screen panel comprises:
a transparent electrode formed on one surface of the encapsulation substrate;
a metal electrode formed on edges or respective sides of the transparent electrode; and
a polarizer film formed on the encapsulation substrate.

12. The display device recited in claim 6, wherein the touch screen panel is driven in a capacitive manner.

13. The display device recited in claim 6, wherein the first display panel and the second display panel are organic light emitting displays.
